(19) United States
(12) Patent Application Publication
(10) Pub. No.: US 2024/0242161 A1
(43) Pub. Date: Jul. 18, 2024

(54) DATA CURRENCY SCORES FOR AN ANALYTICS PLATFORM

(71) Applicant: INTERNATIONAL BUSINESS MACHINES CORPORATION, ARMONK, NY (US)

(72) Inventors: Albert Maier, Tuebingen, DE (US); Mike W. Grasselt, Leinfelden-Echterdingen (DE); Martin Anton Oberhofer, San Jose, CA (US); Alexander Lang, Stuttgart (DE); Sergej Schuetz, Stuttgart (DE); Yannick Saillet, Stuttgart (DE); Werner Schuetz, Nufringen (DE)

(21) Appl. No.: 18/155,921

(22) Filed: Jan. 18, 2023

(51) Int. Cl. G06Q 10/0639

(52) U.S. Cl. CPC G06Q 10/06395

(57) ABSTRACT

An approach is provided for computing and using a currency score. A currency score of a data element is determined as a weighted average of scores of dimensions of the data element. The dimensions include a combination of change frequency, change size, outdated value, and sources score dimensions. Relative to the data element, the change frequency dimension indicates an update frequency, the change size dimension indicates amounts of data being created, updated, and deleted per time unit, the outdated value dimension indicates a portion of values that are not semantically correct, but were semantically correct in the past, and the sources score dimension indicates a currency of input source(s). Based on the currency score, a currency of data included in the data element is evaluated. Based on the currency of the data, a remedial action is performed to improve the currency of the data.

### BACKGROUND

The present invention relates to maintaining data quality, and more particularly to determining a score for data currency for an analytics platform.

Maintaining high data quality for business-critical data and making sure that business decisions are based on high quality data are some of the main challenges for information management. Known analytic platforms offer a feature of a quality score for data, which allows owners and stewards to detect which data needs improvement. Furthermore, the known quality score allows consumers to avoid using data that is deficient in quality, thereby preventing situations in which bad data leads to bad decisions. Known advanced data quality management tools distinguish among many data quality dimensions, including, for example, completeness, uniqueness, and accuracy.

### SUMMARY

In one embodiment, the present invention provides a computer system that includes one or more computer processors; one or more computer readable storage media; and computer readable code stored collectively in the one or more computer readable storage media. The computer readable code includes data and instructions to cause the one or more computer processors to perform operations. The operations include determining a data currency score of a data element as a weighted average of dimension scores of currency dimensions of the data element. The currency dimensions include a combination of (i) a change frequency dimension, (ii) a change size dimension, (iii) an outdated value dimension, and (iv) a sources score dimension. The change frequency dimension indicates a frequency of updates in the data element. The change size dimension indicates amounts of data being created, updated, and deleted in the data element per a unit of time. The outdated value dimension indicates a percentage of values in the data element that are not semantically correct, but were semantically correct in the past. The sources score dimension indicates a currency of one or more input sources of the data element. The operations further include, based on the data currency score, evaluating a currency of data included in the data element. The operations further include, based on the evaluated currency of the data included in the data element, performing a remedial action to improve the currency of the data.

A computer program product and a method corresponding to the above-summarized computer system are also described and claimed herein.

### BRIEF DESCRIPTION OF THE DRAWINGS

FIG. 1 is a block diagram of a system for detecting data changes and for computing, maintaining, and using a data currency score to identify and remedy a data currency issue, in accordance with embodiments of the present invention.

FIG. 2 is a block diagram of modules included in code included in the system of FIG. 1, in accordance with embodiments of the present invention.

FIG. 3 is a flowchart of a process of detecting data changes and for computing, maintaining, and using a data currency score to identify and remedy a data currency issue, in accordance with embodiments of the present invention.

FIG. 4 is a block diagram of a data currency score computation, maintenance, and usage system that is implemented in the system of FIG. 1, in accordance with embodiments of the present invention.

### DETAILED DESCRIPTION

### Overview

The importance of currency (i.e., timeliness) of data is an often-discussed topic in the literature of data quality management, but in practice, there are very few techniques for allowing stewards and end users to be aware of data currency issues (e.g., data in a data element is stale). Being aware of potential data currency issues is the starting point for performing remedial action(s) to fix currency issues, identifying downstream processes or downstream entities that are outdated or affected by stale data, and for avoiding downstream effects, such as avoiding the use of stale data to build artificial intelligence (AI) models for operational business decisions.

The issue of stale data is an increasing problem in modern analytics platforms. The main reason for the stale data issue is that newer architectures and use cases force data to be copied and moved around in an enterprise data landscape. The aforementioned copying and moving of data have been increasing over time. For example, an enterprise may have data for analytics not only in various operational systems, but also in a data warehouse and data marts, in a data lake, and in various training data sets for different AI models stored in departmental project catalogs. Copied data can quickly become stale; e.g., customer data may change with a high percentage per year. This trend increases the urgency to improve a detection of which data is stale and increase an awareness of the degree of staleness of the data. Known platforms may examine data quality assets, such as rules, without examining timeliness of the data itself.

Embodiments of the present invention address the aforementioned unique challenges by automatically computing a novel data currency score from a variety of indicators. Data currency scores are determined with respect to the business nature of the data that is being scored. A data currency score indicates to end users how much data can be trusted with respect to the actual currency of the data compared to a currency expected for the data (e.g., is data being actually updated in accordance with update expectations).

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

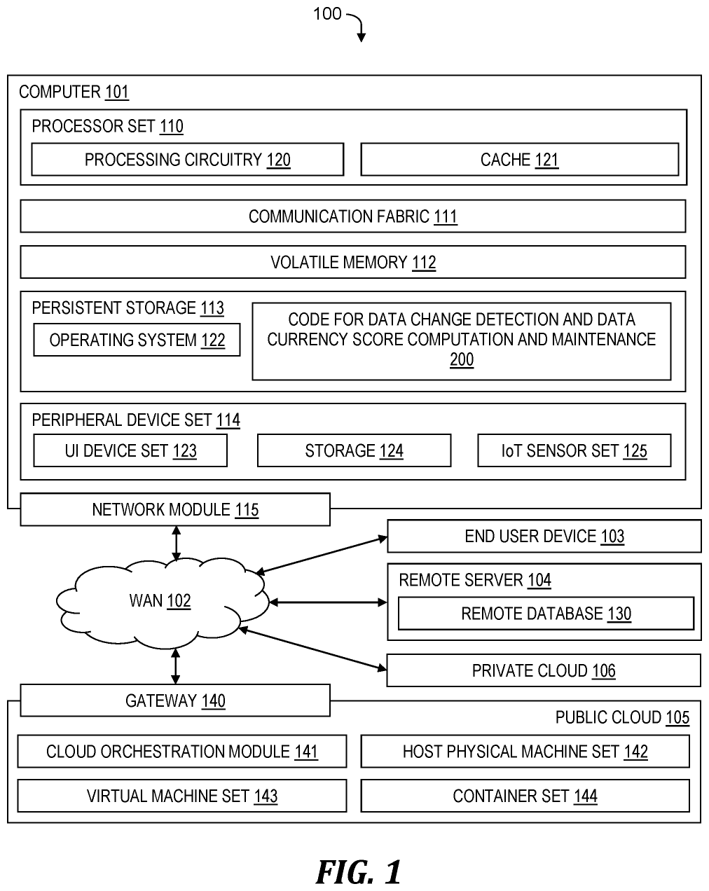

FIG. 1 is a block diagram of a system for detecting data changes and for computing, maintaining, and using a data currency score to identify and remedy data currency issues, in accordance with embodiments of the present invention. Computing environment 100 contains an example of an environment for the execution of at least some of the computer code involved in performing the inventive methods, such as code 200 for data change detection and data currency score computation and maintenance. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Data Currency Score Computation, Maintenance and Usage

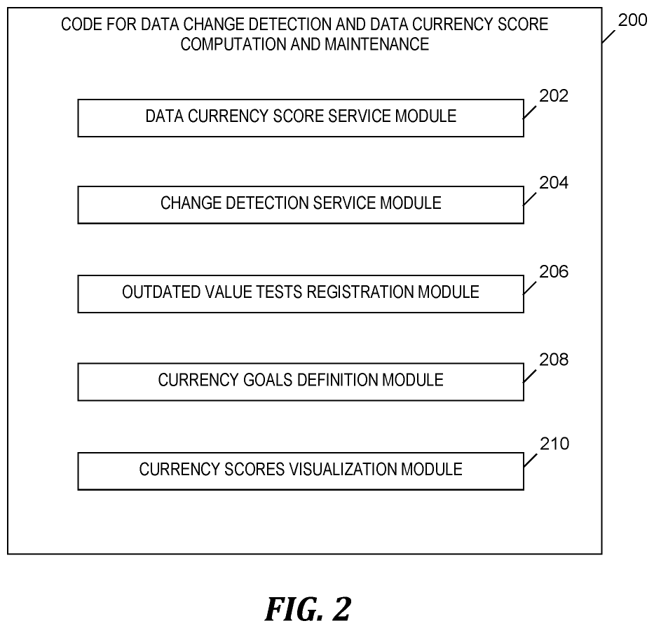

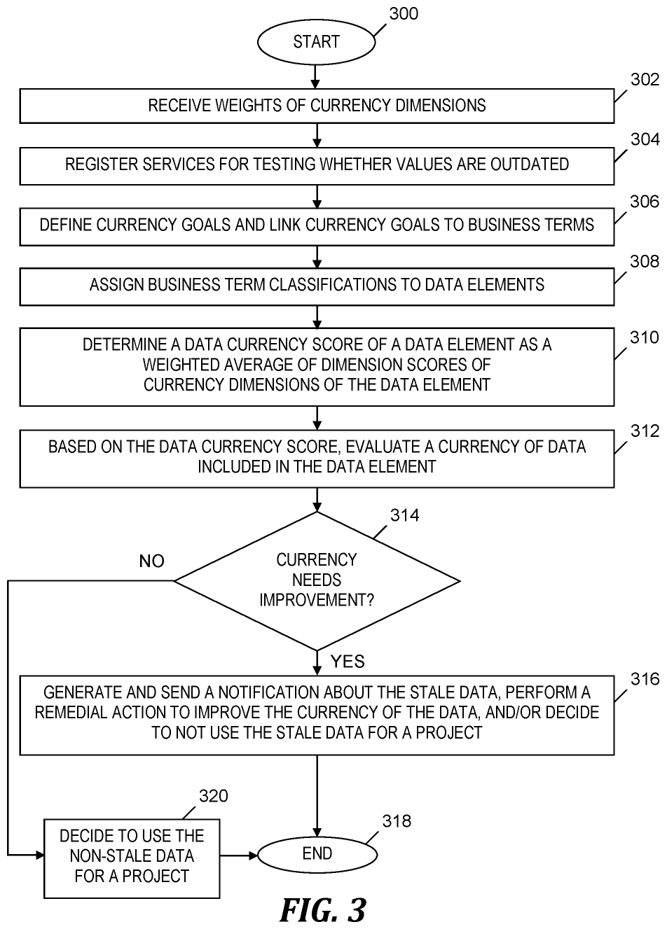

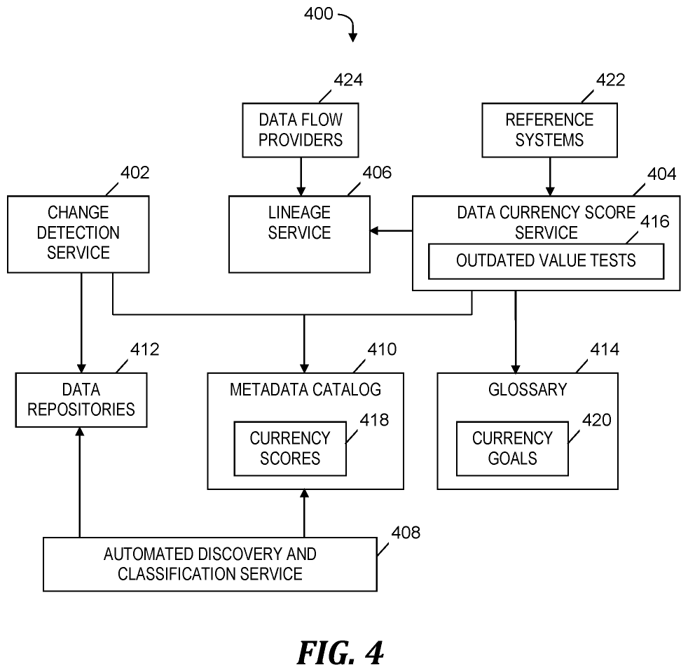

FIG. 2 is a block diagram of modules included in code 200 included in the system of FIG. 1, in accordance with embodiments of the present invention. Code 200 includes a data currency score service module 202, a change detection service module 204, an outdated value tests registration module 206, a currency goals definition module 208, and a currency scores visualization module 210. The functionality of the modules included in code 200 is discussed in detail in the discussion of FIG. 3 and FIG. 4, which is presented below.

FIG. 3 is a flowchart of a process of detecting data changes and for computing, maintaining, and using a data currency score to identify and remedy a data currency issue, in accordance with embodiments of the present invention. The process of FIG. 3 begins at a start node 300. In step 302, data currency score service module 202 receives weights of respective currency dimensions, where the weights are user-configurable and are provided by a technical user via a computer system or computer device operatively coupled to computer 101 (see FIG. 1). In one embodiment, a weight of a currency dimension is a positive number or zero.

In step 304, outdated value tests registration module 206 registers services (i.e., outdated value tests) for testing whether or not values in data elements are outdated. Outdated value tests registration module 206 also links the outdated value tests to business term classifications. The outdated value tests are described in more detail below relative to the discussion of FIG. 4.

In step 306, currency goals definition module 208 defines currency goals in a glossary and links the currency goals to business term classifications. Currency goals are described in more detail below relative to the discussion of FIG. 4.

In step 308, business term classifications are assigned to data elements. In one embodiment, data currency score service module 202 performs the assignments in step 308. In another embodiment, technical users assign the business term classifications to the data elements in step 308.

In step 310, data currency score service module 202 determines (i.e., computes) a data currency score of a data element as a weighted average of dimension scores of currency dimensions of a data element. In one embodiment, step 310 is performed in response to data currency score service module 202 being triggered according to a goal enforcement schedule specific to a particular business term classification. To compute the data currency score, the data currency score service module 202 retrieves information about the last change in the data element and change size characteristics of the data element from a metadata catalog. Prior to step 310, change detection service module 204 populates the metadata catalog with the information about the last change and the change size characteristics by regularly determining the last change and the change size for data elements stored in the metadata catalog. To determine the last change and the change size, change detection service module 204 can use various techniques, such as log investigation, change time stamps, snapshots of data repositories and data sets, and change information stored in data repositories and data sources having temporal characteristics.

The computation of the data currency score and the functionality of the change detection service is described in more detail below relative to the discussion of FIG. 4. After step 310, currency scores visualization module 210 may generate a visualization of the data currency score of the data element for viewing by an end user or for access by a monitoring system. The end user or monitoring system can use data currency scores to send a notification, recommend a remedial action, or perform a remedial action to improve data currency, or to make a decision about using or not using stale data in a downstream process or a downstream entity. For example, the data currency scores may be monitored at regular intervals in the context of a service level agreement (SLA) defined on a platform, where the SLA specifies that a data currency score of X is expected and if X is not reached, then the monitoring system sends a notification or starts a remediation workflow. As another example, the decision to not use stale data can be a decision to not use the data in a machine learning model or to train a machine learning model.

In step 312, based on the data currency score determined in step 310, data currency score service module 202 evaluates a currency (i.e., a timeliness) of data included in the data element. In one embodiment, the evaluation in step 312 includes a determination of whether the data currency score is less than a specified threshold value, thereby indicating that the data in the data element is stale.

In step 314, based on the evaluation of the currency performed in step 312, data currency score service module 202 determines whether the currency of the data needs improvement. If data currency score service module 202 determines in step 314 that the currency of the data needs improvement (i.e., determines that the data is stale), then the Yes branch of step 314 is followed, and step 316 is performed.

In step 316, data currency score service module 202 (i) generates and sends a notification about the data being stale, (ii) performs a remedial action to improve the currency of the data, (iii) receives a manual decision to not use the stale data for a project (e.g., a decision to not use the stale data in a machine learning model or to train a machine learning model), or (iv) a combination of (i), (ii), and (iii). Following step 316, the process of FIG. 3 ends at an end node 318.

Returning to step 314, if data currency score service module 202 determines that the currency of the data does not need improvement (i.e., determines that the data is non-stale), then the No branch of step 314 is followed, and step 320 is performed.

In step 320, data currency score service module 202 receives a manual decision to use the non-stale data for a project. Following step 320, the process of FIG. 3 ends at the end node 318.

FIG. 4 is a block diagram of a data currency score computation, maintenance, and usage system 400 that is implemented in the system of FIG. 1, in accordance with embodiments of the present invention. System 400 includes a change detection service 402, a data currency score service 404, a lineage service 406, an automated discovery and classification service 408, a metadata catalog 410, data repositories 412, and a glossary 414. Data currency score service 404 includes outdated value tests 416. Metadata catalog 410 includes currency scores 418.

Business terms determine the semantics of data. An analytics platform such as IBM® Cloud Pak for Data offers capabilities to auto-assign business terms to classify data elements, such as columns and tables. IBM is a registered trademark of International Business Machines Corporation located in Armonk, New York. Business terms are also referred to herein as business term classifications or classifications. Every column with the same business term classification has the same “update over time” needs; e.g., an enterprise storing home email addresses for their clients may observe that typically about 10% of the home email addresses change per year, whereas the work email addresses for their employees may change by only 1% per year. Similar observations exist for phone numbers, product data, supplier data, etc. Based on these observations, a governance team (not shown) specifies currency goals 420 and currency goals definition module 208 stores the currency goals 420 in glossary 414 and links the currency goals 420 to business terms, which are also stored in glossary 414.

In one embodiment, system 400 distinguishes four currency dimensions:
1. Change frequency, which specifies how often an update of the data in a data element typically happens (i.e., a frequency of updates in the data in the data element).
2. Change size, which specifies amounts of data that are typically created, updated, and deleted per a specified time unit (i.e., specifies percentages of data being created, updated, and deleted, respectively, in the data element per a unit of time).
3. Percentage of outdated values (also referred to herein as an outdated value dimension), which specifies a percentage of values in the data element that are outdated. The outdated values are values that are not currently semantically correct, but were semantically correct in the past. Data currency score service 404 determines semantic correctness or semantic incorrectness by using external services provided by reference systems 422. The external services may include a service for checking whether values in a data element are semantically outdated. For example, an external service for validating a postal address can test whether a postal address value is semantically correct according to semantic correctness standards that may have changed recently because of changes in the organization of a city. Other external services may semantically validate other types of data, such as email addresses, phone numbers, and credit card numbers.
4. Currency of incoming data (also referred to herein as a sources score dimension), which specifies a currency of one or more input sources of the data element. Lineage service 406 investigates the data pipeline via data flows provided by data flow providers 424 to determine the currency of incoming data (i.e., data being input into a data element from one or more input sources (e.g., source columns)).

In another embodiment, system 400 can receive one or more user-defined currency dimensions to add to the four currency dimensions mentioned above, along with user-configurable weights for the one or more user-defined currency dimensions.

In one embodiment, change detection service 402 determines an average currency per currency dimension for each of the existing data elements for a given business term. The governance team uses the aforementioned average currency to define currency goals 420. In one embodiment, currency goals definition module 208 (see FIG. 2) defines currency goals 420 by using the average observed currency characteristics per business term.

In one embodiment, for each data element (e.g., for each column in a table in a database), data currency score service 404 determines currency dimension scores and determines distances between the currency dimension scores and respective currency goals included in currency goals 420. Based on the determined distances, data currency score service 404 computes an aggregated value (i.e., a data currency score) for each data element. Data currency score service 404 stores the data currency score in currency scores 418, which is included in metadata catalog 410. End users (i.e., consumers of the data, such as data scientists and business analysts) can access currency scores 418 and other metadata (e.g., the traditional data quality score that does not incorporate data currency, the owner of the data, etc.) by accessing metadata catalog 410.

In one embodiment, system 400 is an improvement included in a data analytics platform, such as IBM® Cloud Pak for Data, where the improvement adds the computation of data currency scores as another dimension of determining data quality (i.e., the data currency score is included as a new dimension added to multiple existing dimensions that affect an overall data quality score, where the existing dimensions consist of conventional data quality dimensions, such as completeness, uniqueness, and accuracy). In one embodiment, the data analytics platform that includes system 400 includes components specified as follows:

Glossary 414 stores governance artifacts, such as business term classifications, policies, and rules. Glossary 414 also stores currency goals 420.

Metadata catalog 410 stores information about information assets, such as database tables and columns in the database tables. Metadata catalog 410 links the columns and tables to the business terms that classify the columns and tables, thereby defining the business semantics of the columns and tables.

Lineage service 406 collects and maintains information about how data is flowing between source systems and target systems. For example, lineage service 406 collects and maintains information about how data flows from an operational system into a data warehouse, and from the warehouse into a project, where the data is used as training data for a machine learning (ML) model. Lineage service 406 receives data flows from data flow providers 424, such as IBM® DataStage® for ETL flows and IBM® Watson Studio for ML model lineage. DataStage is a registered trademark of International Business Machines Corporation.

Automated discovery and classification service 408 imports metadata about existing information assets into metadata catalog 410 and maintains these imports on a regular basis. Through connections to data repositories 412, automated discovery and classification service 408 detects and classifies tables and columns, including linking the tables and columns to business terms that classify the tables and columns.

In one embodiment, the following new components extend the data analytics platform:
Data currency score service 404 computes and maintains data currency scores for respective columns included in table(s) of a database. In one embodiment, the computation of a data currency score for a given column is based on multiple currency dimensions for the given column. Data currency score service 404 stores the computed data currency scores in the metadata catalog 410. Data currency score service 404 determines source data elements by using lineage service 406. In one embodiment, data currency score service 404 is scheduled; i.e., the computation of the data currency scores runs regularly in the background of a data analytics platform (e.g., runs the data currency scores computations once a week). In one embodiment, data currency score service module 202 (see FIG. 2) implements data currency score service 404.
Outdated value tests registration module 206 (see FIG. 2) registers outdated value tests 416 and links the outdated value tests 416 to business term classifications stored in glossary 414. Data currency score service 404 uses the outdated value tests 416 to check valid column values against external reference systems (i.e., reference systems 422) to determine whether each of the column values is outdated. For example, data currency score service 404 executes a test for outdated postal addresses, where the test is provided by reference systems 422, to determine whether a column value of a postal address is outdated.
Currency goals 420: Currency goals definition module 208 (see FIG. 2) receives definitions of currency goals 420 and stores the currency goals 420 in glossary 414.
Currency scores 418: Currency scores visualization module 210 (see FIG. 2) provides a visualization of currency scores 418 to end users of metadata catalog 410.
Change detection service 402 monitors data updates for source systems using data repositories 412. Change detection service 402 also creates and maintains change data characteristics in metadata catalog 410. Based on the monitored data updates, change detection service 402 determines and monitors change frequencies and change sizes for data elements. In one embodiment, change detection service module 204 (see FIG. 2) implements change detection service 402.

### Using the Components of the Data Analytics Platform

Components of system 400 are used as follows:
1. A technical user modifies the configuration settings in the data currency score service 404 (e.g., the weights for respective currency dimensions, which are described in more detail below). Using the outdated value tests registration module 208 (see FIG. 2), the technical user can register services (i.e., outdated value tests 416) for testing whether or not values are outdated. Outdated value tests 416 are activated by linking the tests to business term classifications. Data currency score service 404 activates a given outdated value test included in outdated value tests 416 for a particular data element based on both the given outdated value test and the particular data element being linked to the same business term classification.
2. Currency goals definition module 208 (see FIG. 2) defines currency goals 420 in glossary 414 and links currency goals 420 to business term classifications. A specification of a currency goal consists of:
   Expected change frequency (i.e., a specified period of time during which an update in the data element is expected) (e.g., updates to a data element are expected to occur at the latest after a duration of seven days)
   Expected change size per unit of time, expressed as a percentage of an entirety of data elements (e.g., 2% of the data elements per month are expected to be creates, 4% of the data elements per month are expected to be updates, and 1% of the data elements per month are expected to be deletes).
   Maximum percentage of outdated values (i.e., the maximum percentage of data in the data element that is tolerated as being not semantically correct, but having been semantically correct in a past time period) (e.g., the maximum tolerated percentage of outdated values is 2% of the data elements).
   Expected minimum overall data currency score
   Goal enforcement schedule; i.e., a time interval at which required checks for the currency goals 420 are required to be executed.

In one embodiment, the expected change size per unit of time currency goal is divided into (i) a first currency goal that specifies an expected percentage of data in the data element being newly created within the unit of time; (ii) a second currency goal that specifies an expected percentage of data in the data element being updated within the unit of time; and (iii) a third currency goal that specifies an expected percentage of data being deleted from the data element within the unit of time.
3. The data analytics platform automatically assigns business term classifications to respective columns. In another embodiment, the assignment of the business term classifications to the columns is performed manually.
4. The data currency score service 404 is triggered according to the time interval specified in the goal enforcement schedule. Data currency score service 404 computes data currency scores for respective columns based on the defined currency goals 420 and stores the computed data currency scores in currency scores 418 within metadata catalog 410. In one embodiment, data currency score service 404 computes a data currency score for a column by performing the following steps a, b, and c:
a. Data currency score service 404 reads information about the last (i.e., most recent) change and change size characteristics of the column from metadata catalog 410. The last change and change size characteristics were populated in metadata catalog 410 by change detection service 402, which is described in more detail below.
b. Data currency score service 404 determines the actual percentage of outdated values in the column by executing the registered outdated value tests 416 based on the schedule defined in the registration of the outdated value tests 416. A given test included in outdated value tests 416 receives a value from the column, executes the test using the received value, and returns a result of the test indicating that the value is current or outdated.
c. Data currency score service 404 requests lineage service 406 to indicate which source columns feed into the column being scored and retrieves all data currency scores for the indicated source columns.
5. In one embodiment, data currency score service 404 or another component of the data analytics platform evaluates the data currency score and, in response to the evaluation of the data currency score, performs an action to react to the data currency score. In another embodiment, a user evaluates the data currency score and reacts based on the evaluated data currency score.

### Change Detection Service

Change detection service 402 regularly determines the last change and change size for data elements stored in data repositories 412. The implementation of change detection service 402 depends on the source system type. In one embodiment, the implementation of change detection service 402 also depends on characteristics of the data element (e.g., depends on a table being a DB2® temporal table rather than a non-temporal table). DB2 is a registered trademark of International Business Machines Corporation. Change detection service 402 may use the following techniques to determine the last change and/or the number of creates, deletes, and updates. Hereinafter, the last change and the number of creates, deletes, and updates are also referred to as the “aforementioned information.”

For relational database management systems, change detection service 402 detects the last change and the number of creates, deletes, and updates by, for example, log investigation.

For files, change detection service 402 exploits change time stamps to collect the aforementioned information.

For a data repository or data source that has temporal characteristics (e.g., DB2® temporal tables), change detection service 402 gathers the aforementioned information directly from the repository or data source.

For any data repository or data set, change detection service 402 takes snapshots at different points in time and makes comparisons among the data in the snapshots, thereby approximating the aforementioned information.

For a given data element, if change detection service 402 cannot detect one or more update characteristics in the aforementioned information (or determines that the detection of the one or more update characteristics is too costly; i.e., has a cost that exceeds a predetermined threshold cost), then change detection service 402 stores an indication that the one or more update characteristics were not computed. In this case, for the computation of the data currency score for the given data element, data currency score service 404 does not consider one or more currency dimensions corresponding to the one or more update characteristics (i.e., the computation of the data currency score treats the one or more currency dimensions as NULL, rather than as zero).

### Data Currency Score Computation

Details of how data currency score service 404 computes a data currency score are described in this section.

The scope of data currency score service 404 includes all applicable columns and their corresponding tables. An applicable column is defined as a column that is (i) stored in metadata catalog 410, (ii) linked to a business term classification, which is linked to a currency goal, and (iii) from a source system that is supported by change detection service 402.

For each applicable column, data currency score service 404 computes a data currency score for a data element as follows:

Data currency score service 404 determines dimension scores for every currency dimension and assigns configurable weights to the currency dimensions. Data currency score service 404 computes a data currency score for the data element as the weighted average of all the dimension scores. To compute the weighted average, data currency score service 404 multiplies every dimension score by its corresponding configured weight and adds the results of the multiplications to obtain a first sum. Data currency score service 404 determines a second sum as a sum of the configured weights. Data currency score service 404 computes the data currency score as the first sum divided by the second sum.

In one embodiment, the aforementioned currency dimensions are considered (i.e., change frequency, change size, percentage of outdated values, and currency of incoming data), with the change size dimension being separated into a change size for deletes, a change size for creates, and a change size for updates, which results in six currency dimensions being considered. Data currency score service 404 computes six dimension scores that are in one-to-one correspondence with the six currency dimensions being considered: (i) change frequency score (cfs), change size score for deletes (cssd), change size score for creates (cssc), change size score for updates (cssu), outdated values score (ovs), and sources score (ss).

The configured weights include weights w_{cfs}, w_{cssd}, w_{cssc}, w_{cssu}, wₒᵥₛ, and wₛₛ that weight cfs, cssd, cssc, cssu, ovs, and ss, respectively.

Data currency score service 404 computes the data currency score for the data element (e.g., computes the data currency score for a column) as:

$$\frac{( cfs \times {w}_{cfs} + cssd \times {w}_{cssd} + cssc \times {w}_{cssc} + cssu \times {w}_{cssu} + ovs \times {w}_{ovs} + ss \times {w}_{ss} )}{( {w}_{cfs} + {w}_{cssd} + {w}_{cssc} + {w}_{cssu} + {w}_{ovs} + {w}_{ss} )}$$

For example, with dimension scores of cfs=0.6, cssd=0.7, cssc=0.7, cssu=0.7, ovs=0.5, and ss=0.9, and with corresponding weights of w_{cfs}=2, w_{cssd}=1, w_{cssc}=1, w_{cssu}=1, wₒᵥₛ=2, and wₛₛ=4, data currency score service 404 computes the data currency score as:

(0.6×2+0.7×1+0.7×1+0.7×1+0.5×2+0.9×4)/(2+1+1+1+2+4),which equals 7.9/11 or 0.72.

### Computing Dimension Scores

Dimension score for change frequency dimension: Data currency score service 404 computes a dimension score for the change frequency dimension by using the following algorithm:

If the currency goal is fulfilled, then the score is 1,

$$else score = number of time units for the goal / number of time units since the last update$$

For example, the time unit=weeks, the number of time units for the currency goal for the change frequency is one week (i.e., the expectation is that a change should happen after a maximum of one week), and the actual amount of time for the change frequency is two weeks. In this case, the dimension score=1/2=0.5.

As another example, if the number of time units for the currency goal is 1 week, and the actual amount of time for the change frequency is 10 weeks, then the dimension score=1/10=0.1.

In one embodiment, data currency score service 404 (i) receives a weight of a dimension score of the change frequency dimension; (ii) determines a currency goal for the change frequency dimension, where the goal is a specified period of time during which an update in the data element is expected; (iii) determines an actual period of time subsequent to a time at which a most recent update in the data element occurred; (iv) determines that the currency goal is not fulfilled by determining that the actual period of time exceeds the specified period of time; and (v) based on the currency goal not being fulfilled, computes the dimension score of the change frequency dimension as the specified period of time divided by the actual period of time.

Dimension scores for change size dimension: Data currency score service 404 computes first, second, and third dimension scores for the change size dimensions for creates, updates, and deletes, respectively, by using the following algorithm for each of the three dimension scores:
If the currency goal is fulfilled, then the score is 1,

$$else score = actual change size / currency goal for the change size dimension$$

For example, if the currency goal for the change size dimension is 10% and the actual change size is 5%, then the dimension score=5/10=0.5.

As another example, if the currency goal for the change size dimension is 10% and the actual change size is 2.5%, then the dimension score=2.5/10=0.25.

With respect to the first dimension score for the change size dimension for creates for a unit of time, data currency score service 404 (i) receives a first weight of a first dimension score of a create dimension included in the change size dimension; (ii) determines a first currency goal for the create dimension, where the first currency goal is a first expected percentage of data in the data element that is newly created data within the unit of time; (iii) determines a first actual percentage of data in the data element that is newly created within the unit of time; (iv) determines that the first currency goal is not fulfilled by determining that the first actual percentage does not exceed the first currency goal; and (v) based on the first currency goal not being fulfilled, computes the first dimension score of the create dimension as the first actual percentage divided by the first expected percentage.

With respect to the second dimension score for the change size dimension for updates for a unit of time, data currency score service 404 (i) receives a second weight of a second dimension score of an update dimension included in the change size dimension; (ii) determines a second currency goal for the update dimension, where the second currency goal is a second expected percentage of data in the data element that is updated within the unit of time; (iii) determines a second actual percentage of data in the data element that is updated within the unit of time; (iv) determines that the second currency goal is not fulfilled by determining that the second actual percentage does not exceed the second currency goal; and (v) based on the second currency goal not being fulfilled, computes the second dimension score of the update dimension as the second actual percentage divided by the second expected percentage.

With respect to the third dimension score for the change size dimension for deletes for a unit of time, data currency score service 404 (i) receives a third weight of a third dimension score of a delete dimension included in the change size dimension; (ii) determines a third currency goal for the delete dimension, where the third currency goal is a third expected percentage of data that is deleted from the data element within the unit of time; (iii) determines a third actual percentage of data in the data element that is deleted from the data element within the unit of time; (iv) determines that the third currency goal is not fulfilled by determining that the third actual percentage does not exceed the third currency goal; and (v) based on the third currency goal not being fulfilled, computes the third dimension score of the delete dimension as the third actual percentage divided by the third expected percentage.

Dimension score for outdated value dimension: Data currency score service 404 computes a dimension score for the percentage of outdated value dimension by using the following algorithm:
If the currency goal is fulfilled, then the score is 1,

$$else score = currency goal for the outdated value dimension / actual percentage of outdated values .$$

For example, if 1% of values is tolerated as being outdated (i.e., currency goal=1%), and the actual percentage of outdated values is 2%, then the dimension score=1/2=0.5.

As another example, if the currency goal is 1% and the actual percentage of outdated values is 4%, then the dimension score=1/4=0.25.

In one embodiment, data currency score service 404 (i) receives a weight of a dimension score of the outdated value dimension; (ii) determines a currency goal for the outdated value dimension, where the currency goal is a maximum percentage of data in the data element that is tolerated as being not semantically correct, but had been semantically correct in a past time period; (iii) determines an actual percentage of data in the data element that is not semantically correct, but was semantically correct in a past time period; (iv) determines that the currency goal is not fulfilled by determining that the actual percentage of data exceeds the maximum percentage of data; and (v) based on the currency goal not being fulfilled, computes the dimension score of the outdated value dimension as the maximum percentage of data divided by the actual percentage of data.

Dimension score for sources score dimension: Data currency score service 404 computes a dimension score for the sources score dimension by using the following algorithm:

Dimension score=the minimum score of the data currency scores of the input columns, where the input columns is the list of all columns that lineage service 406 reports as being an input source for the data element whose data currency score is being computed. In a typical case, the resulting dimension score is the data currency score of a single input column. But in cases in which the data pipeline employs union logic, the dimension score may be based on a plurality of input columns.

In one embodiment, data currency score service 404 (i) receives a weight of a dimension score of the sources score dimension; (ii) sends a request to a lineage service for an identification of one or more input sources of the data element; (iii) based on the request, receives, from the lineage service, the identification of the one or more input sources; (iv) using the identification of the one or more input sources, retrieves one or more respective data currency scores for the one or more input sources; (v) identifies a minimum score of the retrieved one or more respective data currency scores; and (vi) determines the dimension score of the sources score dimension as being the minimum score.

### Table Currency Score

In one embodiment, data currency score service 404 determines a currency score of a table by (i) determining data currency scores of respective columns of the table as weighted averages of dimension scores of currency dimensions of the columns by using the above-described computation of the data currency score for each column and (ii) determining a data currency score of the table as an average of the data currency scores of the respective columns of the table. Based on the data currency score of the table, the data currency score service 404 evaluates the currency of the data included in the table. In one embodiment, based on the evaluated currency of the data in the table, the data currency score service 404 determines that the data included in the table is stale and performs (or recommends) a remedial action to improve the currency of the data included in the table.

What is claimed is:

1. A computer system comprising:
one or more computer processors;
one or more computer readable storage media; and
computer readable code stored collectively in the one or more computer readable storage media, with the computer readable code including data and instructions to cause the one or more computer processors to perform at least the following operations:
determining a data currency score of a data element as a weighted average of dimension scores of currency dimensions of the data element, the currency dimensions including a combination of (i) a change frequency dimension, (ii) a change size dimension, (iii) an outdated value dimension, and (iv) a sources score dimension, wherein the change frequency dimension indicates a frequency of updates in the data element, the change size dimension indicates percentages of data being created, updated, and deleted in the data element per a unit of time, the outdated value dimension indicates a percentage of values in the data element that are not semantically correct, but were semantically correct in the past, and the sources score dimension indicates a currency of one or more input sources of the data element;
based on the data currency score, evaluating a currency of data included in the data element; and
based on the evaluated currency of the data included in the data element, performing a remedial action to improve the currency of the data.

2. The computer system of claim 1, wherein the operations further include:
receiving a weight of a dimension score of the change frequency dimension, the dimension score being included in the dimension scores;
determining a currency goal for the change frequency dimension, the currency goal being a specified period of time during which an update in the data element is expected;
determining an actual period of time subsequent to a time at which a most recent update in the data element occurred;
determining that the currency goal is not fulfilled by determining that the actual period of time exceeds the specified period of time; and
based on the currency goal not being fulfilled, computing the dimension score of the change frequency dimension as the specified period of time divided by the actual period of time,
wherein the determining the data currency score includes computing a sum of products of the dimension scores multiplied by respective weights of the dimension scores and dividing the sum of products by a sum of the respective weights, and wherein the computing the sum of the products includes multiplying the weight by the computed dimension score of the change frequency dimension.

3. The computer system of claim 1, wherein the operations further include:
receiving a first weight of a first dimension score of a create dimension included in the change size dimension, the first dimension score being included in the dimension scores;
determining a first currency goal for the create dimension as a first expected percentage of data in the data element being newly created data in the unit of time;
determining a first actual percentage of data in the data element that is newly created in the unit of time;
determining that the first currency goal is not fulfilled by determining that the first actual percentage does not exceed the first currency goal; and
based on the first currency goal not being fulfilled, computing the first dimension score of the create dimension as the first actual percentage divided by the first expected percentage,
wherein the determining the data currency score includes computing a sum of products of the dimension scores multiplied by respective weights of the dimension scores and dividing the sum of the products by a sum of the respective weights, and wherein the computing the sum of the products includes multiplying the first weight by the computed first dimension score.

4. The computer system of claim 3, wherein the operations further include:
receiving a second weight of a second dimension score of an update dimension included in the change size dimension, the second dimension score being included in the dimension scores;
determining a second currency goal for the update dimension as a second expected percentage of data in the data element being updated in the unit of time;
determining a second actual percentage of data in the data element that is updated in the unit of time;
determining that the second currency goal is not fulfilled by determining that the second actual percentage does not exceed the second currency goal; and
based on the second currency goal not being fulfilled, computing the second dimension score of the update dimension as the second actual percentage divided by the second expected percentage,
wherein the computing the sum of the products further includes multiplying the second weight by the computed second dimension score.

5. The computer system of claim 4, wherein the operations further include:
receiving a third weight of a third dimension score of a delete dimension included in the change size dimension, the third dimension score being included in the dimension scores;
determining a third currency goal for the delete dimension as a third expected percentage of data being deleted from the data element in the unit of time;
determining a third actual percentage of data that is deleted from the data element in the unit of time;
determining that the third currency goal is not fulfilled by determining that the third actual percentage does not exceed the third currency goal; and
based on the third currency goal not being fulfilled, computing the third dimension score of the delete dimension as the third actual percentage divided by the third expected percentage,
wherein the computing the sum of the products further includes multiplying the third weight by the computed third dimension score.

6. The computer system of claim 1, wherein the operations further include:
receiving a weight of a dimension score of the outdated value dimension, the dimension score being included in the dimension scores;
determining a currency goal for the outdated value dimension, the currency goal being a maximum percentage of data in the data element that is tolerated as being not semantically correct, but having been semantically correct in a past time period;
determining an actual percentage of data in the data element that is not semantically correct, but were semantically correct in the past time period;
determining that the currency goal is not fulfilled by determining that the actual percentage of data exceeds the maximum percentage of data; and
based on the currency goal not being fulfilled, computing the dimension score of the outdated value dimension as the maximum percentage of data divided by the actual percentage of data,
wherein the determining the data currency score includes computing a sum of products of the dimension scores multiplied by respective weights of the dimension scores and dividing the sum of the products by a sum of the respective weights, and wherein the computing the sum of the products includes multiplying the weight by the computed dimension score of the outdated value dimension.

7. The computer system of claim 1, wherein the operations further include:
receiving a weight of a dimension score of the sources score dimension, the dimension score being included in the dimension scores;
sending a request to a lineage service for an identification of the one or more input sources of the data element, and based on the request, receiving, from the lineage service, the identification of the one or more input sources;
using the identification of the one or more input sources, retrieving one or more respective data currency scores for the one or more input sources;
identifying a minimum score of the retrieved one or more respective data currency scores; and
determining the dimension score of the sources score dimension as being the minimum score,
wherein the determining the data currency score includes computing a sum of products of the dimension scores multiplied by respective weights of the dimension scores and dividing the sum of the products by a sum of the respective weights, and wherein the computing the sum of the products includes multiplying the weight by the dimension score of the sources score dimension.

8. The computer system of claim 1, wherein the operations further include:
determining data currency scores of respective columns of a table as weighted averages of dimension scores of currency dimensions of the columns by using the determining the data currency score of the data element for each column; and
determining a data currency score of the table as an average of the data currency scores of the respective columns;
based on the data currency score of the table, evaluating a currency of data included in the table; and
based on the evaluated currency of the data included in the table, performing a remedial action to improve the currency of the data included in the table.

9. A computer program product comprising:
one or more computer readable storage media having computer readable program code collectively stored on the one or more computer readable storage media, the computer readable program code being executed by one or more processors of a computer system to cause the computer system to perform at least the following operations:
determining a data currency score of a data element as a weighted average of dimension scores of currency dimensions of the data element, the currency dimensions including a combination of (i) a change frequency dimension, (ii) a change size dimension, (iii) an outdated value dimension, and (iv) a sources score dimension, wherein the change frequency dimension indicates a frequency of updates in the data element, the change size dimension indicates percentages of data being created, updated, and deleted in the data element per a unit of time, the outdated value dimension indicates a percentage of values in the data element that are not semantically correct, but were semantically correct in the past, and the sources score dimension indicates a currency of one or more input sources of the data element;
based on the data currency score, evaluating a currency of data included in the data element; and
based on the evaluated currency of the data included in the data element, performing a remedial action to improve the currency of the data.

10. The computer program product of claim 9, wherein the operations further include:
receiving a weight of a dimension score of the change frequency dimension, the dimension score being included in the dimension scores;
determining a currency goal for the change frequency dimension, the currency goal being a specified period of time during which an update in the data element is expected;
determining an actual period of time subsequent to a time at which a most recent update in the data element occurred;
determining that the currency goal is not fulfilled by determining that the actual period of time exceeds the specified period of time; and
based on the currency goal not being fulfilled, computing the dimension score of the change frequency dimension as the specified period of time divided by the actual period of time,
wherein the determining the data currency score includes computing a product of the dimension scores multiplied by respective weights of the dimension scores and dividing the product by a sum of the respective weights, and wherein the computing the product includes multiplying the weight by the computed dimension score of the change frequency dimension.

11. The computer program product of claim 9, wherein the operations further include:
receiving a first weight of a first dimension score of a create dimension included in the change size dimension, the first dimension score being included in the dimension scores;
determining a first currency goal for the create dimension as a first expected percentage of data in the data element being newly created data in the unit of time;
determining a first actual percentage of data in the data element that is newly created in the unit of time;
determining that the first currency goal is not fulfilled by determining that the first actual percentage does not exceed the first currency goal; and
based on the first currency goal not being fulfilled, computing the first dimension score of the create dimension as the first actual percentage divided by the first expected percentage,
wherein the determining the data currency score includes computing a product of the dimension scores multiplied by respective weights of the dimension scores and dividing the product by a sum of the respective weights, and wherein the computing the product includes multiplying the first weight by the computed first dimension score.

12. The computer program product of claim 11, wherein the operations further include:
receiving a second weight of a second dimension score of an update dimension included in the change size dimension, the second dimension score being included in the dimension scores;
determining a second currency goal for the update dimension as a second expected percentage of data in the data element being updated in the unit of time;
determining a second actual percentage of data in the data element that is updated in the unit of time;
determining that the second currency goal is not fulfilled by determining that the second actual percentage does not exceed the second currency goal; and
based on the second currency goal not being fulfilled, computing the second dimension score of the update dimension as the second actual percentage divided by the second expected percentage,
wherein the computing the product further includes multiplying the second weight by the computed second dimension score.

13. The computer program product of claim 12, wherein the operations further include:
receiving a third weight of a third dimension score of a delete dimension included in the change size dimension, the third dimension score being included in the dimension scores;
determining a third currency goal for the delete dimension as a third expected percentage of data being deleted from the data element in the unit of time;
determining a third actual percentage of data that is deleted from the data element in the unit of time;
determining that the third currency goal is not fulfilled by determining that the third actual percentage does not exceed the third currency goal; and
based on the third currency goal not being fulfilled, computing the third dimension score of the delete dimension as the third actual percentage divided by the third expected percentage,
wherein the computing the product further includes multiplying the third weight by the computed third dimension score.

14. The computer program product of claim 9, wherein the operations further include:
receiving a weight of a dimension score of the outdated value dimension, the dimension score being included in the dimension scores;
determining a currency goal for the outdated value dimension, the currency goal being a maximum percentage of data in the data element that is tolerated as being not semantically correct, but having been semantically correct in a past time period;
determining an actual percentage of data in the data element that is not semantically correct, but were semantically correct in the past time period;
determining that the currency goal is not fulfilled by determining that the actual percentage of data exceeds the maximum percentage of data; and
based on the currency goal not being fulfilled, computing the dimension score of the outdated value dimension as the maximum percentage of data divided by the actual percentage of data,
wherein the determining the data currency score includes computing a product of the dimension scores multiplied by respective weights of the dimension scores and dividing the product by a sum of the respective weights, and wherein the computing the product includes multiplying the weight by the computed dimension score of the outdated value dimension.

15. The computer program product of claim 9, wherein the operations further include:
receiving a weight of a dimension score of the sources score dimension, the dimension score being included in the dimension scores;
sending a request to a lineage service for an identification of the one or more input sources of the data element, and based on the request, receiving, from the lineage service, the identification of the one or more input sources;
using the identification of the one or more input sources, retrieving one or more respective data currency scores for the one or more input sources;
identifying a minimum score of the retrieved one or more respective data currency scores; and
determining the dimension score of the sources score dimension as being the minimum score,
wherein the determining the data currency score includes computing a product of the dimension scores multiplied by respective weights of the dimension scores and dividing the product by a sum of the respective weights, and wherein the computing the product includes multiplying the weight by the dimension score of the sources score dimension.

16. The computer program product of claim 9, wherein the operations further include:
determining data currency scores of respective columns of a table as weighted averages of dimension scores of currency dimensions of the columns by using the determining the data currency score of the data element for each column; and
determining a data currency score of the table as an average of the data currency scores of the respective columns;
based on the data currency score of the table, evaluating a currency of data included in the table; and
based on the evaluated currency of the data included in the table, performing a remedial action to improve the currency of the data included in the table.

17. A computer-implemented method comprising:
determining, by one or more processors, a data currency score of a data element as a weighted average of dimension scores of currency dimensions of the data element, the currency dimensions including a combination of (i) a change frequency dimension, (ii) a change size dimension, (iii) an outdated value dimension, and (iv) a sources score dimension, wherein the change frequency dimension indicates a frequency of updates in the data element, the change size dimension indicates percentages of data being created, updated, and deleted in the data element per a unit of time, the outdated value dimension indicates a percentage of values in the data element that are not semantically correct, but were semantically correct in the past, and the sources score dimension indicates a currency of one or more input sources of the data element;
based on the data currency score, evaluating, by the one or more processors, a currency of data included in the data element; and
based on the evaluated currency of the data included in the data element, performing, by the one or more processors, a remedial action to improve the currency of the data.

18. The method of claim 17, further comprising:
receiving, by the one or more processors, a weight of a dimension score of the change frequency dimension, the dimension score being included in the dimension scores;
determining, by the one or more processors, a currency goal for the change frequency dimension, the currency goal being a specified period of time during which an update in the data element is expected;
determining, by the one or more processors, an actual period of time subsequent to a time at which a most recent update in the data element occurred;
determining, by the one or more processors, that the currency goal is not fulfilled by determining that the actual period of time exceeds the specified period of time; and
based on the currency goal not being fulfilled, computing, by the one or more processors, the dimension score of the change frequency dimension as the specified period of time divided by the actual period of time,
wherein the determining the data currency score includes computing a product of the dimension scores multiplied by respective weights of the dimension scores and dividing the product by a sum of the respective weights, and wherein the computing the product includes multiplying the weight by the computed dimension score of the change frequency dimension.

19. The method of claim 17, further comprising:
receiving, by the one or more processors, a first weight of a first dimension score of a create dimension included in the change size dimension, the first dimension score being included in the dimension scores;
determining, by the one or more processors, a first currency goal for the create dimension as a first expected percentage of data in the data element being newly created data in the unit of time;
determining, by the one or more processors, a first actual percentage of data in the data element that is newly created in the unit of time;
determining, by the one or more processors, that the first currency goal is not fulfilled by determining that the first actual percentage does not exceed the first currency goal; and
based on the first currency goal not being fulfilled, computing, by the one or more processors, the first dimension score of the create dimension as the first actual percentage divided by the first expected percentage,
wherein the determining the data currency score includes computing a product of the dimension scores multiplied by respective weights of the dimension scores and dividing the product by a sum of the respective weights, and wherein the computing the product includes multiplying the first weight by the computed first dimension score.

20. The method of claim 19, further comprising:
receiving, by the one or more processors, a second weight of a second dimension score of an update dimension included in the change size dimension, the second dimension score being included in the dimension scores;
determining, by the one or more processors, a second currency goal for the update dimension as a second expected percentage of data in the data element being updated in the unit of time;
determining a second actual percentage of data in the data element that is updated in the unit of time;
determining, by the one or more processors, that the second currency goal is not fulfilled by determining that the second actual percentage does not exceed the second currency goal; and
based on the second currency goal not being fulfilled, computing, by the one or more processors, the second dimension score of the update dimension as the second actual percentage divided by the second expected percentage,
wherein the computing the product further includes multiplying the second weight by the computed second dimension score.
